(19) United States
(12) Patent Application Publication
(10) Pub. No.: US 2004/0051606 A1
(43) Pub. Date: Mar. 18, 2004

(54) Performance of electric solenoids and sensors by cryogenic treatment of component parts

(76) Inventor: Russell Miles Modien, Chatham (CA)

Correspondence Address: Siemens Corporation, Intellectual Property Department, 186 Wood Avenue South, Iselen, NJ, 08830, US

(21) Appl. No.: 10/246,568

(22) Filed: Sep. 18, 2002

(51) Int. Cl. H01C 10/30

(52) U.S. Cl. 335/220

(57) ABSTRACT

Friction and/or wear resistance of relatively moving component parts in various devices, such as electric position sensors and solenoids, is improved by cryogenic treatment of lamina on component parts. Such treatment of coil, stator, armature, and/or housing of a solenoid also improves solenoid efficiency.

### FIELD OF THE INVENTION

The invention relates to improving the performance of various devices that have moving parts, including solenoids and certain electric sensors. In particular, the invention relates to improving performance by cryogenic treatment of certain elements of the devices.

### BACKGROUND OF THE INVENTION

Electric solenoids and certain electric sensors, such as position sensors for sensing position of an armature of a solenoid, have relatively moving parts that are in surface-to-surface contact. It may be possible to improve performance of such devices by reducing friction and/or increasing wear resistance of such relatively moving parts. Use of certain coatings, low-friction coatings for example, is a known procedure for obtaining such improvement.

Improvement in the efficiency of a magnetic circuit of a solenoid may be achieved by improving the electrical and/or magnetic characteristics of the materials forming the electromagnet, including the electromagnet coil, the stator, and the armature.

### SUMMARY OF THE PRESENT INVENTION

It is toward further improvements in reducing friction and/or increasing wear resistance of relatively moving component parts of such devices that the present invention is directed.

It is also toward further improvements in the efficiency of a magnetic circuit of a solenoid that the present invention is directed.

Accordingly, one general aspect of the invention relates to a method for improving wear resistance between two relatively movable elements of a device that are in mutual surface-to-surface contact, one of the elements comprising a substrate having a surface to which a lamina that provides the contact with the other element has been applied. The method comprises cooling the lamina to a temperature near absolute zero and terminating the cooling before using the device.

Another general aspect of the invention relates to a method for improving wear resistance between two relatively movable elements of a device that are in mutual surface-to-surface contact while relatively moving. The method comprises applying to a surface of one of the elements a lamina that provides the contact of the one element with the other element, cooling the applied lamina to a temperature near absolute zero, and terminating the cooling before assembling the one element into the device.

Still another general aspect of the invention relates to a device having relatively movable elements that have mutual surface-to-surface contact while relatively moving. One of the elements comprises a cryogenically treated lamina that is disposed on a surface of one of the elements and that provides the contact of the one element with the other element while the elements are relatively moving.

One more general aspect of the invention relates to a method of improving performance of a solenoid that comprises an electromagnet coil, a stator, and an armature. The method comprises cryogenically treating at least one of said coil, said stator, and said armature.

The following description of one or more presently preferred embodiments of the invention will serve to disclose principles of the invention in accordance with a best mode contemplated for carrying out the invention.

### BRIEF DESCRIPTION OF THE DRAWINGS

FIG. 1 is a schematic drawing of a generic solenoid to which principles of the present invention may be applied.

FIG. 2 is a schematic drawing of a generic sensor to which principles of the invention may be applied.

FIG. 3 is a graph plot representative of improvements attainable with the invention.

FIG. 4 is another graph plot.

### DESCRIPTION OF THE PREFERRED EMBODIMENT

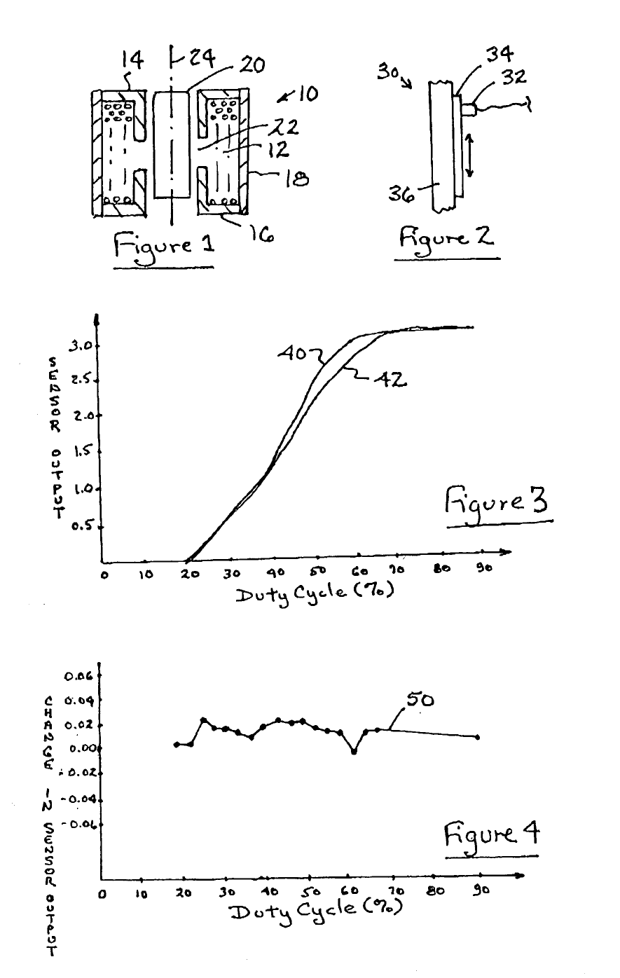

FIG. 1 shows a generic solenoid 10 comprising an electromagnet coil 12, an upper stator 14, a lower stator 16, an outer shell 18, and an armature 20, with the upper and lower stators providing an air gap 22 at which armature 20 is disposed. When coil 12 is energized, a magnetic force is applied to armature 20 along an axis 24. Armature 20 may be part of a mechanism for operating a valve, such as an automotive emission control valve, one example of which is an EGR valve.

FIG. 2 shows a generic sensor 30 where a contact 32 moves along a lamina 34 on a substrate 36.

Cryogenic treatment has been used to subject certain materials to temperature extremes approaching absolute zero. Such treatment may create certain material changes that are retained at least to some extent when the extreme cooling terminates and the material temperature returns to ambient. Examples of such material changes are phase changes and grain structure changes. It is believed that such changes can have certain lasting beneficial effects for parts that are made of cryogenically treated materials.

It is also believed that most investigations into the benefits of cryogenic treatment of materials have involved metals, and consequently, benefits to amorphous or semi-crystalline materials may not be established.

A first example of the application of principles of the present invention involves electric sensors, rotary or linear, where a contact moves along a lamina on a substrate. The lamina may be a material that exhibits either electrical resistivity or electrical conductivity. An example of a paste is one that contains a mixture of conductive and non-conductive particles.

For any of various reasons, including environmental reasons like vibration, temperature, humidity, and contamination, wear can occur in the lamina at any point where the contact bears against the lamina. This can alter the electric characteristic of the sensor. Known sensor designs may be a compromise between relatively softer lamina that may be less prone to changing conductivity but wears faster, and relatively harder lamina that does not wear as fast but whose conductivity is more prone to conductivity change.

Cryogenic treatment of the lamina can improve wear resistance of the lamina while also minimizing change in electric conductivity due to use. The lamina is typically a paste or ink that has been deposited onto the substrate. In the case of a paste, the paste is allowed to cure before being subjected to cryogenic treatment. In the case of an ink, the ink is allowed to first dry.

The part is then placed in a cryogenic chamber, and cooled to cryogenic temperatures. After the cooling has ended, the chamber is opened and the part is removed. The part is then assembled into the device in which it is to be used. After cooling to near absolute zero, the temperature of the part is allowed to recover to ambient in a controlled manner that may include some thermal cycling for stress relief purposes.

It is believed that low-friction lamina, such as PTFE, PTFE mixtures, and PTFE compounds, can also benefit from such cryogenic treatment. Such lamina are applied to parts that have surface-to-surface contact as they move. The motion of an armature within a solenoid is one example.

PTFE by itself has relatively poor wear resistance in certain applications. Cryogenic treatment of PTFE, including mixtures and compounds thereof, before use can improve wear resistance while maintaining low coefficient of friction.

Cryogenic treatment of certain component parts of a solenoid, such as an electromagnet coil and magnetic materials in the magnetic circuit, can improve solenoid performance. For example, greater force per unit of electric current may result. It is believed that such benefit is due to the creation of a more orderly atomic and/or molecular structure in the materials involved. Stators, armatures, coils, and housings of solenoids can be cryogenically treated.

The graph of FIG. 3 is representative of improvement that is attainable by applying the process to both stator and armature parts of a solenoid that is used to open a valve. The horizontal axis represents duty cycle of a pulse width modulated (PWM) signal applied to coil 12, the vertical axis, armature travel along axis 24 that results from the PWM signal, as measured by a position sensor. A first plot 40 is for a solenoid having both stator and armature parts cryogenically treated. A second plot 42 is for the same solenoid, but without the parts having been cryogenically treated. Comparison of the two plots shows that in general, as the duty cycle increases, the motion imparted to the armature will be greater when both stator and armature parts have been cryogenically treated in comparison to lack of such treatment. The difference becomes more significant as the valve approaches full open condition where the knees of the plots are.

FIG. 4 comprises a graph plot 50 that illustrates the comparative benefit of using an armature that has been cryogenically treated versus one that has not. A number of solenoid samples were evaluated, some having only the upper stator cryogenically treated, others only the lower stator treated, and still others both stators treated. Each solenoid was evaluated using a cryogenically treated armature in one instance, and a non-cryogenically treated armature in another instance.

For each type of armature, the solenoid was subjected to a number of different duty cycles, and the resulting sensor voltage measured at each duty cycle. At each duty cycle, the difference between the sensor voltage using the treated armature and that using the non-treated one was calculated, and the differences for all solenoids averaged. It is those averages that have been plotted to yield graph plot 50.

The averages show a general improvement by using a treated armature in comparison to a non-treated one, although there was variation from sample to sample, with some samples performing better than others. It is believed that this data is evidential of meaningful improvement that can be obtained with the invention, as applied to a solenoid armature.

While the foregoing has described a preferred embodiment of the present invention, it is to be appreciated that the inventive principles may be practiced in any form that falls within the scope of the following claims.

What is claimed is:

1. A method for improving wear resistance between two relatively movable elements of a device that are in mutual surface-to-surface contact, one of the elements comprising a substrate having a surface to which a lamina that provides the contact with the other element has been applied, the method comprising:
cooling the lamina to a temperature near absolute zero; and
terminating the cooling before using the device.

2. A method as set forth in claim 1 wherein the cooling and terminating steps are performed before the one element is assembled into the device, and the method includes the further step of assembling the one element into the device after the terminating step.

3. A method for improving wear resistance between two relatively movable elements of a device that are in mutual surface-to-surface contact while relatively moving, the method comprising:
applying to a surface of one of the elements a lamina that provides the contact of the one element with the other element;
cooling the applied lamina to a temperature near absolute zero; and
terminating the cooling before assembling the one element into the device.

4. A method as set forth in claim 3 wherein the step of applying a lamina to a surface of the one element comprises applying an electrically resistive lamina to the surface of the one element.

5. A method as set forth in claim 3 wherein the step of applying a lamina to a surface of the one element comprises applying an electrically conductive lamina to the surface of the one element.

6. A method as set forth in claim 3 wherein the step of applying a lamina to a surface of the one element comprises applying a paste to the surface of the one element and curing the paste before the cooling step is performed.

7. A method as set forth in claim 3 wherein the step of applying a lamina to a surface of the one element comprises applying an ink to the surface of the one element and drying the ink before the cooling step is performed.

8. A method as set forth in claim 3 wherein the step of applying a lamina to a surface of the one element comprises applying a low friction lamina to the surface of the one element before the cooling step is performed.

9. A method as set forth in claim 3 wherein the step of applying a lamina to a surface of the one element comprises applying a lamina containing PTFE to the surface of the one element before the cooling step is performed.

10. A device having relatively movable elements that have mutual surface-to-surface contact while relatively moving, wherein one of the elements comprises:
a cryogenically treated lamina that is disposed on a surface of one of the elements and that provides the contact of the one element with the other element while the elements are relatively moving.

11. A device as set forth in claim 10 wherein the device comprises an electric sensor wherein the cryogenically treated lamina comprises an electrically resistive lamina.

12. A device as set forth in claim 10 wherein the device comprises an electric sensor wherein the cryogenically treated lamina comprises an electrically conductive lamina.

13. A device as set forth in claim 10 wherein the cryogenically treated lamina comprises a cured paste.

14. A device as set forth in claim 10 wherein the cryogenically treated lamina comprises a dried ink.

15. A device as set forth in claim 10 wherein the cryogenically treated lamina comprises a low friction material.

16. A device as set forth in claim 10 wherein the cryogenically treated lamina comprises PTFE as a constituent.

17. A method of improving performance of a solenoid that comprises an electromagnet coil, a stator, and an armature, the method comprising:
cryogenically treating at least one of said coil, said stator, and said armature.

18. A solenoid made according to the method of claim 17.

19. A solenoid according to claim 18 wherein at least said stator and said armature have been cryogenically treated.
